(19) United States
(12) Patent Application Publication
(10) Pub. No.: US 2025/0037417 A1
(43) Pub. Date: Jan. 30, 2025

(54) CONTINUOUS ADJUSTMENT OF LIGHTING THROUGH VIDEO STREAM

(71) Applicant: INTERNATIONAL BUSINESS MACHINES CORPORATION, ARMONK, NY (US)

(72) Inventors: Jeffrey Bisti, New Paltz, NY (US); Robert Paquin, Poughkeepsie, NY (US); PHILIP SICONOLFI, Croton on Hudson, NY (US)

(21) Appl. No.: 18/359,088

(22) Filed: Jul. 26, 2023

(51) Int. Cl. G06V 10/60; G06V 10/74; H04N 5/57; H04N 7/15

(52) U.S. Cl. CPC G06V 10/60; G06V 10/761; H04N 5/57; H04N 7/15

(57) ABSTRACT

According to one embodiment, a method, computer system, and computer program product for continuous lighting adjustment through a video stream is provided. The embodiment may include identifying a lighting system. The embodiment may also include determining a lighting goal. The embodiment may further include analyzing a scene in a video stream, wherein one or more lighting features of the video stream are illuminated by the lighting system. The embodiment may also include comparing at least one lighting feature of the scene to the lighting goal. While the lighting goal is not met, the embodiment may include adjusting a lighting system according to the lighting goal, and repeating the analyzing and comparing until the lighting goal is met.

### BACKGROUND

The present invention relates generally to the field of computing, and more particularly to the Internet of Things (IoT).

IoT is a conception of the internet as a network of not only typical computing devices, but also a variety of objects and fixtures connected to that network. These objects may have or may be connected to processors, radios, or sensors, and may have related capabilities such as internet access or programmable features. IoT brings together several different technologies to power smart homes, smart cities, and a variety of different businesses. A smart home may, for example, bring computational features to kitchens, thermostats, lighting systems, and sound systems.

### SUMMARY

According to one embodiment, a method, computer system, and computer program product for continuous lighting adjustment through a video stream is provided. The embodiment may include identifying a lighting system. The embodiment may also include determining a lighting goal. The embodiment may further include analyzing a scene in a video stream, wherein one or more lighting features of the video stream are illuminated by the lighting system. The embodiment may also include comparing at least one lighting feature of the scene to the lighting goal. While the lighting goal is not met, the embodiment may include adjusting a lighting system according to the lighting goal, and repeating the analyzing and comparing until the lighting goal is met.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for continuous adjustment of lighting through a video stream.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to IoT. The following described exemplary embodiments provide a system, method, and program product to, among other things, continuously adjust a lighting system by use of a video stream. Therefore, the present embodiment has the capacity to improve the technical field of IoT by allowing for iterated adaptive lighting to achieve a particular lighting goal through use of computer vision on a video stream.

As previously described, IoT is a conception of the internet as a network of not only typical computing devices, but also a variety of objects and fixtures connected to that network. These objects may have or may be connected to processors, radios, or sensors, and may have related capabilities such as internet access or programmable features. IoT brings together several different technologies to power smart homes, smart cities, and a variety of different businesses. A smart home may, for example, bring computational features to kitchens, thermostats, lighting systems, and sound systems.

Lighting is an increasingly important bottleneck in high-quality video and photo applications. Lighting can also dramatically impact mood and productivity in person. Poor lighting can ruin a scene, and great lighting can make an otherwise unremarkable scene excellent. However, few users of lighting systems truly understand how to take advantage of their full potential to best illuminate a scene. As such, it may be advantageous to use a video stream of a scene to adjust a lighting system until a lighting goal is met.

According to one embodiment, a program for continuous adjustment of lighting through a video stream is provided. The continuous lighting adjustment program may initialize a video stream and identify a lighting system. The continuous lighting adjustment program may then determine a lighting goal. The continuous lighting adjustment program may then analyze a scene in the video. The scene may then be compared to the lighting goal. If the lighting goal is not met, the lighting may be adjusted according to the lighting goal. Afterwards, the continuous lighting adjustment program may pause, for example to reevaluate the scene or compare the adjusted scene to a new lighting goal. The continuous lighting adjustment program may then return to the analysis step until the scene or video stream ends.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

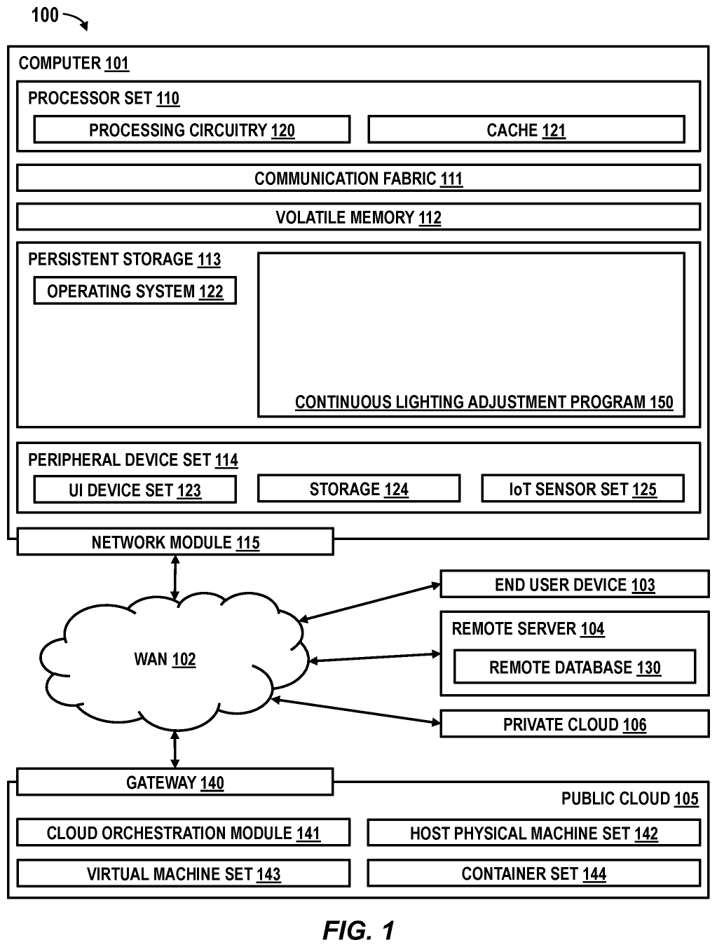

Referring now to FIG. 1, computing environment 100 contains an example of an environment for the execution of at least some of the computer code involved in performing the inventive methods, such as continuous lighting adjustment program 150. In addition to continuous lighting adjustment program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and continuous lighting adjustment program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed conversation is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in continuous lighting adjustment program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in continuous lighting adjustment program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The continuous lighting adjustment program 150 may initialize a video stream and identify a lighting system. The continuous lighting adjustment program 150 may then determine a lighting goal for a scene in the video stream. The continuous lighting adjustment program 150 may then evaluate the scene. The continuous lighting adjustment program 150 may then compare the scene to the lighting goal. If the lighting goal is not met, the continuous lighting adjustment program 150 may adjust the lighting system according to the lighting goal. The continuous lighting adjustment program 150 may then pause before assessing whether or not to continue the process of continuous lighting for the scene. If the process of continuous lighting adjustment should continue, the continuous lighting adjustment program 150 may return to evaluating the scene; if continuous lighting adjustment should end, the continuous lighting adjustment program 150 may then complete its operation.

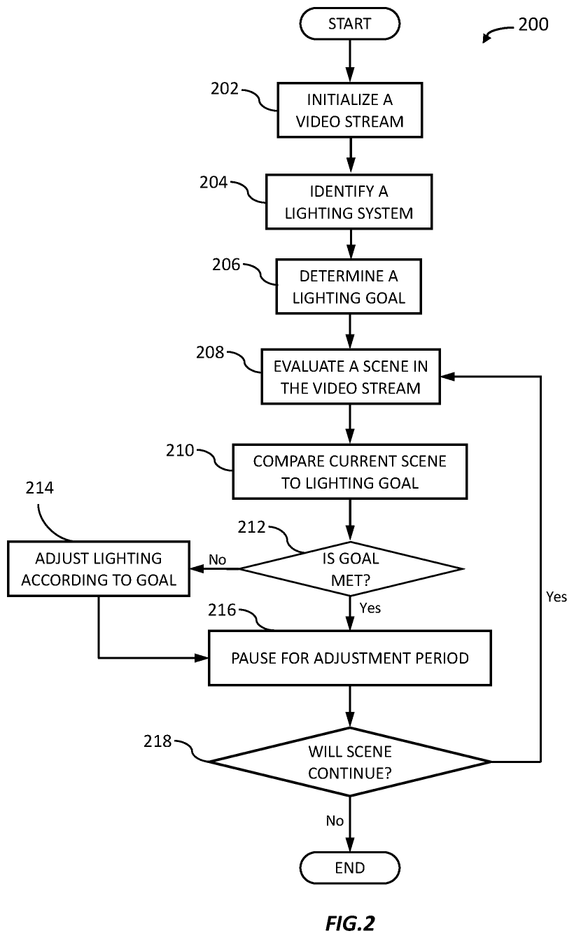

Furthermore, notwithstanding depiction in computer 101, continuous lighting adjustment program 150 may be stored in and/or executed by, individually or in any combination, end user device 103, remote server 104, public cloud 105, and private cloud 106. The continuous lighting adjustment method is explained in more detail below with respect to FIGS. 2.

Referring now to FIG. 2, an operational flowchart for a process for continuous adjustment of lighting with a video stream 200 is depicted according to at least one embodiment. At 202, the continuous lighting adjustment program 150 initializes a video stream. A video stream may include a local or internet-connected video stream. A video stream may be initialized by a user, by another program, automatically at a set time, or automatically at a time determined by an algorithmic method.

In at least one embodiment, a video stream may be an internet-connected video stream. For example, a video stream may be a video stream shared with a web conference, an internet-connected security system video stream, a one-to-many social media stream, or a friendly group chat.

Alternatively, a video stream may be a local video stream. For example, a video stream may be the video input collected by a camera for a camera viewfinder, a local security system's video stream, or a video stream captured by a dedicated lighting control client application such as the continuous lighting adjustment program 150.

A video stream may be initialized by a user, by another program, automatically at a set time, or automatically at a time determined by an algorithmic method. An algorithmic method may include a process of artificial intelligence or a method for reacting to data obtained from elsewhere. For example, an algorithmic method may initialize a video stream 23 minutes before sunset as determined by polling a local API that shares sunset times.

In at least one embodiment, the continuous lighting adjustment program 150 may initialize video streams in more than one location. For example, in the context of a video conference, the continuous lighting adjustment program 150 may initialize a video stream for each user at each user's location.

In another embodiment, a video stream may include other data, such as audio information, metadata about the stream itself or about the device that captured the stream, or information about a user collected according to opt-in procedures. A video stream may include a typical video or any other series of multiple frames of visual input, including a series of photographs taken by a camera in succession.

In an alternate embodiment, the continuous lighting adjustment program 150 may initialize more than one video stream at a given location. For example, the continuous lighting adjustment program 150 may capture video of a scene from multiple angles. Alternatively, the continuous lighting adjustment program 150 may capture video of a scene using multiple camera modules on one device, where each camera module captures video with different parameters, such as different exposure or different white balance.

Then, at 204, the continuous lighting adjustment program 150 identifies one or more lighting systems. A lighting system may be an IoT-connected light source or a system for controlling a light source, including, for example, an IoT-connected set of blinds. A lighting system may be identified through an internet connection, Bluetooth® connection, Wi-Fi connection, wired connection, smart home system, similar network connection, or combination of connections.

In at least one embodiment, a lighting system may include an IoT-enabled or network-connected light source, such as a “smart” light bulb, “smart” LED device such as a ring light, a display such as a television or a computer monitor that is sufficiently bright to act as a light source, a light source integrated into another device such as a camera flash module or a lighting system integrated into a computer, or a smart-home-connected fireplace.

Alternatively, a lighting system may include a system for controlling a light source, such as an IoT-enabled light switch; a smart home system; a rail system for positioning light bulbs; a wheeled base upon which a lamp may be mounted; an IoT-enabled window, blind system, shutter system, or curtain system; or any other system that may change the tone, brightness, color, intensity, transparency, or position of a light source, or partially or fully block the light source.

A lighting system may be identified through an internet connection, Bluetooth® connection, Wi-Fi connection, wired connection, smart home system, similar network connection, or combination of connections. A lighting system may be selected manually by a user or automatically. For example, a user may select a lighting system from a drop down list, or the continuous lighting adjustment program 150 may select the nearest lighting system. Alternatively, the continuous lighting adjustment program 150 may identify a lighting system in the stream using computer vision techniques. As another alternative, the continuous lighting adjustment program 150 may connect to multiple lighting systems and test each one, checking the video stream to understand the results of the test.

Identifying a lighting system may include identifying features of the lighting system, such as technical specifications, model numbers, a category of the system (such as “smart bulb,” “rail system,” and “smart home control system”), an estimated location of the system (based, for example, on smart home data or on the results of a video test as described above), or a battery level.

A lighting system may include one or more of the above fixtures or systems. The continuous lighting adjustment program 150 may identify one or more lighting systems at a given location, and may identify lighting systems at one or more locations. Lighting systems may be identified, disconnected, or reconnected at any point during the process for continuous adjustment of lighting with a video stream 200.

Next, at 206, the continuous lighting adjustment program 150 determines a lighting goal for a scene in the video stream. A lighting goal may be set by a user, may be determined by an algorithmic process, or may be a default lighting goal. A lighting goal can be generic (such as “best possible lighting), role-based, based on preset styles, moods, or filters; may be based on a preexisting scene; or may be based on a natural language commands submitted by a user. A lighting goal may be defined in terms of brightness, color, tone, shadows, or other directly measurable effects, or in terms of more abstract objectives, such as maximum overall clarity, or best approximation of a particular aesthetic. A lighting goal may be set per user, per scene, per stream, or overall across a set of streams, such as one lighting goal for a meeting.

In at least one embodiment, a lighting goal may be set by a user. A user may select a lighting goal, for example, by selecting from a list of preset options, such as “red,” “green,” and “blue,” or “professional video,” “professional portrait,” “disco,” and “romantic.” Alternatively, a user may select a lighting goal by supplying a reference video stream that is known to have good lighting, for example by providing a video directly, selecting another video stream from step 202, or by providing a link to a reference video. As another example, a user may select a lighting goal by issuing a natural language command by text or audio, such as “give me some calming lighting for a while,” or “please match the mood of whatever song is playing for the next three hours, but revert to neutral lighting when the music is paused.” A lighting goal may be the plain text of a natural language command, or may be interpreted by the continuous lighting adjustment program 150, for example by a process of artificial intelligence using an artificial neural network and trained language model and used to determine a lighting goal in a different format, or generate a new lighting goal, such as a filter generated by artificial intelligence or a generated sample video designed to demonstrate the determined lighting goal.

Alternatively, a lighting goal may be determined by an algorithmic process. An algorithmic process may include a simple selection based on information collected at any step above: for example, based on metadata indicating that the video stream is part of a business meeting, the continuous lighting adjustment program 150 may select a lighting goal associated with lighting participants in business meetings. Alternatively, an algorithmic process may use computer vision on a video stream to identify a human subject as the primary subject in the scene, and therefore select a lighting goal of optimal lighting of a human subject. As another alternative, a lighting goal may be a process of artificial intelligence, including advanced techniques such as use of an artificial neural network trained on feedback obtained from past operation of the continuous lighting adjustment program 150. For example, an artificial intelligence may notice that several subjects are lit inconsistently by natural light, may find a pattern where past users gave negative feedback for inconsistent lighting but positive feedback for natural light with consistent lighting, and may set a lighting goal of balancing lighting to light the subjects evenly without otherwise disturbing the natural tone or effect of the existing light.

A lighting goal may also be selected by default. For example, a lighting goal may always be set to light human subjects well until and unless another lighting goal is selected. Alternatively, a lighting goal may be set according to one or more user roles. For example, on a meeting with multiple users from different teams, a sales team may be lit in a green tone, a product team may be lit in a subtle red tone, and a legal team may be lit in a blue tone.

A lighting goal may be defined in terms of brightness, color, tone, shadows, or other directly measurable effects, or in terms of more abstract objectives, such as maximum overall clarity, or best approximation of a particular aesthetic. A lighting goal may include specific features, such as “set every lighting source to maximum brightness” or “ensure that light is all coming from the top left of the frame in video stream A to cast shadows towards the bottom right,” or abstract objectives, such as “get as close to a spaghetti western aesthetic as possible,” or “give off chill vibes.”

Then, at 208, the continuous lighting adjustment program 150 analyzes or evaluates a scene in the video stream. A scene may be the entire video stream, a subject within a video stream, an area within the video stream, or an area around the general location of a video stream, as may be affected by a lighting system. A scene may be recognized, analyzed, or evaluated using computer vision, including image comparison techniques, or using a process of artificial intelligence. Analyzing a scene may include analyzing the environment, subject, lighting, or sound in the scene as well as metadata about the scene.

A scene may be the entire video stream, a subject within a video stream, an area within the video stream, or an area around the general location of a video stream, as may be affected by a lighting system. A scene may be selected or recognized using computer vision, including image comparison techniques, or using a process of artificial intelligence, and based on any information collected above, including by use of another video stream, analysis of audio, roles of the users, a lighting goal, or information about a lighting system, or based on user input describing an expected scene. For example, if a user describes a scene as depicting dialogue, and a visual recognition method recognizes two subjects in the video stream, the scene may be an area around and between the two subjects. Alternatively, if visual recognition identifies lighting sources in the video stream, the scene may be identified as the entire area covered by the lighting sources except the lighting sources themselves.

A scene may further be analyzed or evaluated using computer vision, including image comparison techniques, or using a process of artificial intelligence, and in light of any information collected above. For example, a computer vision technique may recognize that the colors found in a scene are very undersaturated. Alternatively, if a user describes a scene as depicting dialogue, a visual recognition technique may find that one of two faces in the scene is insufficiently lit to recognize. As yet another example, a process of artificial intelligence may utilize an artificial neural network trained on feedback obtained from users of the continuous lighting adjustment program 150, and thereby recognize certain objects as being in the background or foreground of the scene.

Analyzing a scene may include analyzing the environment, subject, lighting, colors, tones, brightness measurements, or sound in the scene as well as metadata about the scene, including the lighting goal, a time and place where the video stream was recorded, information about viewers or likely viewers or information about the bit rate of the video stream. For example, analyzing may include matching sounds in the scene resembling speech to lip movements found in the scene using visual recognition. Alternatively, analyzing may include determining that a viewer is red-green colorblind. Analyzing may further include analyzing a level of activity or motion in the scene, determining an overall mood of the scene, or drawing any other inferences about the content of the scene that may be useful to continuous lighting adjustment program 150.

Next, at 210, the continuous lighting adjustment program 150 compares the analyzed scene to the lighting goal. Comparison may be performed using computer vision, including image comparison techniques, or using a process of artificial intelligence. Comparison may include, for example, determining a degree of similarity, closeness, or aesthetic matching between the analyzed scene and the lighting goal, a binary measure of whether a lighting goal is met, or a list of ways in which the scene is similar from or different from the lighting goal. Comparison may be performed based on overall similarity, or based on one or more features.

Comparison may be performed using computer vision, including image comparison techniques, or using a process of artificial intelligence. For example, if a lighting goal refers to another video containing a similar scene to the analyzed scene, comparison may involve using computer vision techniques to compare the lighting of the two scenes. Alternatively, if a goal is a mood, comparison may use a process of artificial intelligence to gauge the mood of the current scene and compare the current mood to the goal mood. Comparison of moods may utilize, for example, known techniques of sentiment analysis. As another example, if a lighting goal describes particular numerical ranges of brightness, color, tone, and balance specifications, comparison may compare these specifications in a video stream to the specifications of the lighting goal.

Comparison may include, for example, determining a degree of similarity, closeness, or aesthetic matching between the analyzed scene and the lighting goal, a binary measure of whether a lighting goal is met, or a list of ways in which the scene is similar from or different from the lighting goal. Comparison may be performed based on overall similarity, or based on one or more features. For example, comparison may determine whether or not the color, brightness, and clarity of a scene have met the lighting goal within a threshold of 15 points on abstract scales of similarity of color, of brightness, and of clarity. Alternatively, comparison may determine a difference in nits between the average brightness of a subject between the scene and the lighting goal. As another example, comparison may note that, compared to a previous comparison, the current scene is farther from the lighting goal than it was one second ago, or that the overall hue of a scene is farther from the lighting goal but the brightness is closer to the lighting goal.

Comparison may be performed based on one or more video streams capturing a scene. Comparison may include using camera metadata or multiple video streams to account for inaccuracies by a certain camera or device—for example, if a phone's camera driver tends to capture light as more saturated than it appears on other cameras, comparison may account for this tendency. Comparison may also utilize information from other sources, such as information collected from a smart LED ring light or an IoT-connected light sensor near the scene.

Comparing a scene to a lighting goal may be performed over time or based on one or more frames of a video stream. For example, the brightness statistics used for a scene may be based on an average of brightness over the course of the previous 30 frames of video in the video stream. As another example, if a lighting goal involves a fun mood for a disco-themed dance party, an artificial intelligence algorithm may gauge mood for a scene based on the past three seconds of the lighting in the scene, capturing the frequency and degree by which colors change. Building on this example, if a reference scene for a lighting goal shows lights changing colors suddenly three times per second, and the current scene shows lights changing by a similar amount, but gradually over the course of one second, the continuous lighting adjustment program 150 may make note of this distinction in the way the lights change over time.

Then, at step 212, the continuous lighting adjustment program 150 determines whether or not the lighting goal has been met. The continuous lighting adjustment program 150 may determine that the goal has been met based on the results of comparison, for example according to a range or a threshold distance of an overall comparison value, or of a number of particular comparison values. If the continuous lighting adjustment program 150 determines that the lighting goal has been met, (step 212, “Yes” branch), then the process for continuous adjustment of lighting with a video stream 200 may proceed to step 216 to pause the video stream for an adjustment period. If the continuous lighting adjustment program 150 determines the lighting goal has not been met (step 212, “No” branch), then the process for continuous adjustment of lighting with a video stream 200 may proceed to step 214 to adjust the lighting system according to the lighting goal.

Determining that a lighting goal has been met may be determined according to a range or a threshold distance of an overall comparison value, or of a number of particular comparison values. For example, determining that a lighting goal has been met may include determining that, given four abstract 100-point scales for hue, brightness, saturation, and sharpness, and comparisons indicating the distance on these scales between the lighting goal and the current scene, a lighting goal may be met where the sum of the difference of each of the four scales is 37 points or less, the largest difference is no more than 14 points, and brightness in particular is no more than five points from the lighting goal.

Next, at 214, the continuous lighting adjustment program 150 adjusts lighting according to the lighting goal. Adjusting may include determining and affecting adjustments. Adjusting lighting may include deciding to change or changing brightness, color, tones, positions, special effects or other features of a lighting system; directing a change to a lighting system, including a “smart” blind; reverting a previous change to a lighting system; or reverting a lighting system as a whole to a neutral or baseline state of lighting. Adjustments may be determined in absolute terms, or in relative terms from current lighting or from a neutral or baseline state.

Adjustments may be determined in absolute terms. For example, a first adjustment to a lighting system may be to set parameters for the lighting system to preset values according to a lighting goal's preselected filter, or to values that are known to work well, generally, for the lighting system and the environment.

Adjustments may be made based on a change from a previous adjustment or previous state. For example, if a previous adjustment was found to have brought lighting closer to the lighting goal, adjusting may continue to make similar changes. Alternatively, if a previous adjustment was found to take lighting further from a lighting goal, adjusting may include reverting lighting to a previous state where lighting was closer to the lighting goal, and then making a different adjustment. If a previous adjustment was found to bring brightness closer to a lighting goal but introduce warm tones that are farther from the lighting goal, a new adjustment may be to continue to change brightness but revert a change in color temperature, or to reduce color temperature relative to the previous state.

In another example, adjusting may include determining multiple separate plans of adjustment, and beginning one plan of adjustment, and continuing until that plan reaches a Pareto-efficient point (a point which can no longer be improved by a direct change). After this adjustment is complete, a future adjustment may revert to a neutral or baseline state and begin a separate plan of adjustment, again until reaching a point of Pareto efficiency. After each plan of adjustment is complete, adjusting may include selecting the result that is closest to the lighting goal from the individual Pareto-efficient results of each plan.

In an alternate embodiment, adjusting lighting may include setting lighting to a random state, for example to escape a loop of insufficient lighting patterns or to test a new perspective. Furthermore, adjusting may include directing a lighting system to issue a signal, such as a very brief flash of a particular color, to the continuous lighting adjustment program 150 as a test to, for instance, better understand the scene, the lighting system, or the camera capturing a video stream.

Adjusting may include using camera metadata, display metadata, or multiple video streams to account for inaccuracies by a certain camera, display, or device—for example, if a phone's camera driver tends to capture light as more saturated than it appears on other cameras, adjusting a lighting system may account for this tendency. Alternatively, in the context of a business meeting, adjusting may include adjusting to ensure that the output video on each meeting participant's display is within a certain threshold of the lighting goal, or may include creating multiple output video streams accounting for the variance between different displays.

Then, at 216, the continuous lighting adjustment program 150 pauses from adjusting lighting. The length of a pause may be a fixed time or number of frames, or may be selected dynamically by the continuous lighting adjustment program 150. The continuous lighting adjustment program 150 may pause any and all function while paused, or may perform any other function, such as determining a new lighting goal, analyzing a scene, comparing a scene to the lighting goal, identifying a new lighting system, disconnecting a lighting system, identifying a new video stream, or determining whether or not a scene should continue.

The length of a pause may be a fixed time or number of frames, or may be selected dynamically by the continuous lighting adjustment program 150. For example, the continuous lighting adjustment program 150 may always pause for one frame of video in a video stream, or for a minimal unit of functional time given the processor of the device on which the continuous lighting adjustment program 150 is running.

Alternatively, the length of a pause may be selected dynamically according to the time the continuous lighting adjustment program 150 finds necessary to wait to see a change in the video stream. The continuous lighting adjustment program 150 may, for example, determine that if the lighting goal has been met by a small threshold, it is necessary to pause for five seconds and only adjust the lighting further if environmental lighting factors such as sunlight change; that if the lighting goal has been met by a large threshold, it is only necessary to pause for three seconds, as lighting may be improved easily; and that if the lighting goal has not been met, the pause should only be 0.2 seconds so that the continuous lighting adjustment program 150 may continue to adjust the lighting quickly.

As another alternative, the continuous lighting adjustment program 150 may pause until at least the process for continuous adjustment of lighting with a video stream 200 returns to step 214 and must again adjust the lighting according to the lighting goal based on a newly captured frame of the video stream.

Finally, at 218, if the continuous lighting adjustment program 150 determines that the scene should continue, (step 218, “Yes” branch), then the process for continuous adjustment of lighting with a video stream 200 may return to step 208 to analyze the stream with the adjusted lighting. If the continuous lighting adjustment program 150 determines the lighting goal has not been met (step 218, “No” branch), then the process for continuous adjustment of lighting with a video stream 200 may end.

The continuous lighting adjustment program 150 may determine, for example, that the scene should continue by default; on the condition that the lighting goal has not been met, in general or beyond some threshold; based on user input selecting that the continuous lighting adjustment program 150 should continue; as determined by artificial intelligence; or based on any other condition, event, or input. Alternatively, the continuous lighting adjustment program 150 may determine that the scene should end, for example, by user input selecting that the continuous lighting adjustment program 150 should end, including, for example, an input ending the video stream or turning off the lighting system; based on a condition that the lighting goal has been met, in general or beyond some threshold; as determined by artificial intelligence; at a set time, such as one hour after the video stream begins; by default, unless it is determined that the stream should continue; or based on any other condition, event, or input.

An end to the process for continuous adjustment of lighting with a video stream 200 may include leaving the lighting system in its current adjusted state; restoring the lighting system 200 to a neutral state, a predetermined state, or an earlier state that was determined to be relatively good or relatively close to the lighting goal; relinquishing control of the lighting system to a user or another program; or turning the lighting system off.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a lighting system;
determining a lighting goal;
analyzing a scene in a video stream, wherein one or more lighting features of the video stream are illuminated by the lighting system;
comparing at least one lighting feature of the scene to the lighting goal; and
in response to determining the lighting goal is not satisfied, adjusting the lighting system according to the lighting goal;
repeating the analyzing and the comparing through one or more iterations.

2. The method of claim 1, wherein the video stream is part of an internet meeting.

3. The method of claim 1, wherein the lighting goal includes a reference to a target video stream.

4. The method of claim 1, wherein evaluating the scene includes evaluating a sequence of multiple frames in the scene.

5. The method of claim 1, wherein adjusting includes reverting a previous adjustment that did not bring the scene closer to the lighting goal.

6. The method of claim 1, wherein the repeating further comprises repeating the analyzing and the repeating occurs until the lighting goal is met.

7. The method of claim 1, further comprising:
pausing for a pause period wherein adjusting does not occur during the pause period.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a lighting system;
determining a lighting goal;
analyzing a scene in a video stream, wherein one or more lighting features of the video stream are illuminated by the lighting system;
comparing at least one lighting feature of the scene to the lighting goal; and
in response to determining the lighting goal is not satisfied, adjusting the lighting system according to the lighting goal;
repeating the analyzing and the comparing through one or more iterations.

9. The computer system of claim 8, wherein the video stream is part of an internet meeting.

10. The computer system of claim 8, wherein the lighting goal includes a reference to a target video stream.

11. The computer system of claim 8, wherein evaluating the scene includes evaluating a sequence of multiple frames in the scene.

12. The computer system of claim 8, wherein adjusting includes reverting a previous adjustment that did not bring the scene closer to the lighting goal.

13. The computer system of claim 8, wherein the repeating further comprises repeating the analyzing and the repeating occurs until the lighting goal is met.

14. The computer system of claim 8, further comprising:
pausing for a pause period wherein adjusting does not occur during the pause period.

15. A computer program product, the computer program product comprising:
one or more computer-readable tangible storage media and program instructions stored on at least one of the one or more tangible storage media, the program instructions executable by a processor capable of performing a method, the method comprising:
identifying a lighting system;
determining a lighting goal;
analyzing a scene in a video stream, wherein one or more lighting features of the video stream are illuminated by the lighting system;
comparing at least one lighting feature of the scene to the lighting goal; and
in response to determining the lighting goal is not satisfied, adjusting the lighting system according to the lighting goal;
repeating the analyzing and the comparing through one or more iterations.

16. The computer program product of claim 15, wherein the video stream is part of an internet meeting.

17. The computer program product of claim 15, wherein the lighting goal includes a reference to a target video stream.

18. The computer program product of claim 15, wherein evaluating the scene includes evaluating a sequence of multiple frames in the scene.

19. The computer program product of claim 15, wherein adjusting includes reverting a previous adjustment that did not bring the scene closer to the lighting goal.

20. The computer program product of claim 15, wherein the repeating further comprises repeating the analyzing and the repeating occurs until the lighting goal is met.
